(19) United States
(12) Patent Application Publication
(10) Pub. No.: US 2010/0302465 A1
(43) Pub. Date: Dec. 2, 2010

(54) IMAGE DISPLAY DEVICE, PROJECTOR, AND METHOD OF CONTROLLING THE SAME

(75) Inventor: Takanori Shoji, Matsumoto-shi (JP)

Correspondence Address: ADVANTEDGE LAW GROUP, LLC, 922 W. BAXTER DRIVE, SUITE 100, SOUTH JORDAN, UT, 84095, US

(73) Assignee: Seiko Epson Corporation, Tokyo (JP)

(21) Appl. No.: 12/791,930

(22) Filed: Jun. 2, 2010

(30) Foreign Application Priority Data
Jun. 2, 2009 (JP) 2009-132842

(51) Int. Cl. H04N 5/91; H04N 9/31

(52) U.S. Cl. 348/744; 348/E09.025; 386/E05.003

(57) ABSTRACT

An image display device includes: an image reproduction section adapted to reproduce image information recorded on a recording medium mounted; an image display section adapted to display an image corresponding to the image information reproduced by the image reproduction section; a control section adapted to make the image reproduction section start reproduction of the image information if the recording medium is mounted to the image reproduction section; and an authentication section adapted to perform user authentication, wherein the control section inhibits the image reproduction section from reproducing image information until the authentication by the authentication section becomes successful.

The entire disclosure of Japanese Patent Application No. 2009-132842 filed Jun. 2, 2009 is expressly incorporated by reference herein.

### BACKGROUND

1. Technical Field

The present invention relates to an image display device provided with an image reproduction section for reproducing image information recorded on a recording medium, a projector, and a method of controlling the image display device.

2. Related Art

In an image display device for displaying an image, there are known those integrally provided with an image reproduction section for reproducing image information recorded on a recording medium such as a digital versatile disc (DVD) or a Blu-ray disc (see, e.g., JP-A-2005-99617). By using such an image display device, it becomes possible to easily appreciate the image based on the image information recorded on the recording medium without connecting an external image reproduction device.

However, such an image display device as described above can easily be used for appreciating an image, and therefore, might be used by an unauthorized user without permission in the case in which it is located in a company or a school.

### SUMMARY

An advantage of some aspects of the invention is to solve at least a part of the problem described above, and can be realized as following embodiments or application examples.

### Application Example 1

According to Application Example 1 of the invention, there is provided an image display device including an image reproduction section adapted to reproduce image information recorded on a recording medium mounted, an image display section adapted to display an image corresponding to the image information reproduced by the image reproduction section, a control section adapted to make the image reproduction section start reproduction of the image information if the recording medium is mounted to the image reproduction section, and an authentication section adapted to perform user authentication, wherein the control section inhibits the image reproduction section from reproducing image information until the user authentication by the authentication section becomes successful.

According to the image display device of this application example, since the reproduction of the image information is not started until the user authentication becomes successful, it becomes possible to prevent unauthorized use by unauthorized users.

### Application Example 2

According to Application Example 2 of the invention, in the image display device of the above application example of the invention, it is possible that a recording medium conveying section adapted to load the recording medium from outside and to mount the recording medium to the image reproduction section, and a loading operation detection section adapted to detect a loading operation for making the recording medium conveying section load the recording medium are further provided, and the recording medium conveying section loads the recording medium and then ejects the recording medium outside if the loading operation detection section detects the loading operation before the user authentication by the authentication section becomes successful.

According to the image display device of this application example of the invention, since the recording medium once loaded is ejected even if the operation for loading the recording medium is performed before the authentication by the authentication section becomes successful, it is possible to make the user recognize that the reproduction of the image information is not achievable until the user authentication becomes successful.

### Application Example 3

According to Application Example 3 of the invention, in the image display device of the above application example of the invention, it is possible that a recording medium conveying section adapted to load the recording medium from outside and to mount the recording medium to the image reproduction section, and a loading operation detection section adapted to detect a loading operation for making the recording medium conveying section load the recording medium are further provided, and the recording medium conveying section inhibits loading of the recording medium if the loading operation detection section detects the loading operation before the user authentication by the authentication section becomes successful.

According to the image display device of this application example of the invention, since the recording medium is not loaded even if the operation for loading the recording medium is performed before the authentication by the authentication section becomes successful, it is possible to make the user recognize that the reproduction of the image information is not achievable until the user authentication becomes successful.

### Application Example 4

According to Application Example 4 of the invention, in the image display device of the above application example of the invention, it is possible that a recording medium conveying section adapted to load the recording medium from outside and to mount the recording medium to the image reproduction section is further provided, and the recording medium conveying section inhibits ejection of the recording medium, which is loaded prior to power ON, until the user authentication by the authentication section becomes successful.

According to the image display device of this application example, since the recording medium is not ejected even if the operation for ejecting the recording medium is performed before the authentication by the authentication section becomes successful, it is possible to make the user recognize that the ejection of the recording medium is not achievable until the user authentication becomes successful.

### Application Example 5

According to Application Example 5 of the invention, in the image display device of the above application example of the invention, it is possible that a mechanism adapted to mount the recording medium to the image reproduction section is a slot-in mechanism.

According to the image display device of this application example, because the mechanism for mounting recording medium is implemented as the slot-in mechanism, for example, the user can directly insert the recording medium into a slot to load such a medium without difficulty.

### Application Example 6

According to Application Example 6 of the invention, in the image display device of the above application example of the invention, it is possible that a mechanism adapted to mount the recording medium to the image reproduction section is a tray loading mechanism.

According to the image display device of this application example, because the mechanism for mounting recording medium is implemented as the tray loading mechanism, for example, the user can set the recording medium on a tray to load such a medium without difficulty.

### Application Example 7

According to Application Example 7 of the invention, in the image display device of the above application example of the invention, it is possible that a mechanism adapted to mount the recording medium to the image reproduction section is a top-loading mechanism.

According to the image display device of this application example, because the mechanism for moutning recording medium is implemented as the top-loading mechanism, for example, generally, a top-loading mechanism is including a turntable on which a recording medium is placed and a lid for covering the turntable, the user can set the recording medium on the turntable without difficulty.

### Application Example 8

According to Application Example 8 of the invention, in the image display device of the above application example of the invention, it is possible that the authentication section determines whether a user authentication function is active or inactive, and performs the user authentication if the user authentication function is active, and the control section inhibits the image reproduction section from reproducing image information until the user authentication by the authentication section becomes successful.

According to the image display device of this application example, it is possible to perform the user authentication based on the availability of the user authentication function. The user can selectively set the activity of the user authentication function in the image display device according to security requirement.

### Application Example 9

According to Application Example 9 of the invention, there is provided a projector including an image reproduction section adapted to reproduce image information recorded on a recording medium mounted, an image display section adapted to display an image corresponding to the image information reproduced by the image reproduction section, a control section adapted to make the image reproduction section start reproduction of the image information if the recording medium is mounted to the image reproduction section and an authentication section adapted to perform user authentication, wherein the control section inhibits the image reproduction section from reproducing image information until the user authentication by the authentication section becomes successful, and the image display section performs an image projection to project the image corresponding to the image information reproduced by the image reproduction section.

According to the projector of this application example, since the reproduction of the image information is not started until the user authentication becomes successful, it becomes possible to prevent unauthorized use by unauthorized users.

### Application Example 10

According to Application Example 10 of the invention, in the image display device of the above application example of the invention, it is possible that a light source adapted to supply illumination light for the image projection is further provided, wherein the projector is powered ON, the light source is made to make transition to a lighting state, and the user authentication is performed by performing one of the loading operation and the reproduction operation in a standby state with the light source put OFF, and if the user authentication is unsuccessful, the projector is powered OFF and made to make transition to a playback inhibition state as a standby state for putting OFF the light source.

According to the projector of this application example, since the light source does not turn on until the user authentication becomes successful, it becomes possible to prevent unauthorized use by unauthorized user.

### Application Example 11

According to Application Example 11 of the invention, there is provided a method of controlling an image display device having an image reproduction section adapted to reproduce image information recorded on a recording medium mounted including the steps of (a) detecting a loading operation adapted to load the recording medium from outside and mount the recording medium to the image reproduction section, (b) performing user authentication if the loading operation is detected, and (c) inhibiting reproduction of the image information by the image reproduction section if the user authentication is unsuccessful in step (b).

According to the method of controlling an image display device of this application example, since the reproduction of the image information is not started until the user authentication becomes successful, it becomes possible to prevent unauthorized use by unauthorized users.

### Application Example 12

According to Application Example 12 of the invention, in the method of controlling an image display device of the above application example of the invention, wherein the recording medium is loaded and then ejected outside if the loading operation is detected in step (b) before the user authentication in step (b) becomes successful.

According to the method of this application example, because the recording medium can not be loaded if the loading operation is detected before the user authentication, it becomes possible to prevent unauthorized use by unauthorized users.

### Application Example 13

According to Application Example 13 of the invention, in the image display device of the above application example of the invention, wherein loading of the recording medium from outside is inhibited if the loading operation is detected in step (a) before the user authentication in step (b) becomes successful.

According to the method of this application example, because loading the recording medium is inhibited before the user authentication, it becomes possible to prevent unauthorized use by unauthorized users.

### BRIEF DESCRIPTION OF THE DRAWINGS

The invention will be described with reference to the accompanying drawings, wherein like numbers reference like elements.

FIG. 1 is a perspective view of a projector.

FIG. 2 is a block diagram showing a circuit configuration of the projector.

FIG. 3 is a flow chart for explaining an operation of the projector in the case in which a power key or a playback key is operated in a standby state.

FIG. 4 is an explanatory diagram showing an authentication image.

FIG. 5 is a flowchart for explaining an operation of the projector in the case in which an eject key is operated in the standby state.

FIG. 6 is a flowchart for explaining an operation of the projector in the case in which a DVD medium is inserted in a disk slot in the standby state.

### DESCRIPTION OF AN EXEMPLARY EMBODIMENT

Hereinafter, the projector as one of image display devices will be explained with reference to the accompanying drawings. The projector according to the present embodiment is provided with a DVD playback section capable of performing playback of digital versatile discs (DVD), and is able to project images based on the image information recorded on the DVD media. Further, the projector according to the present embodiment is provided with a user authentication function for performing authentication of the user using a secret number, and is capable of permitting or inhibiting the use of the projector based on the secret number input by the user. It should be noted that the user authentication function described above can be switched between a valid state and an invalid state, and in the invalid state of the user authentication function, the projector can be used without inputting the secret number.

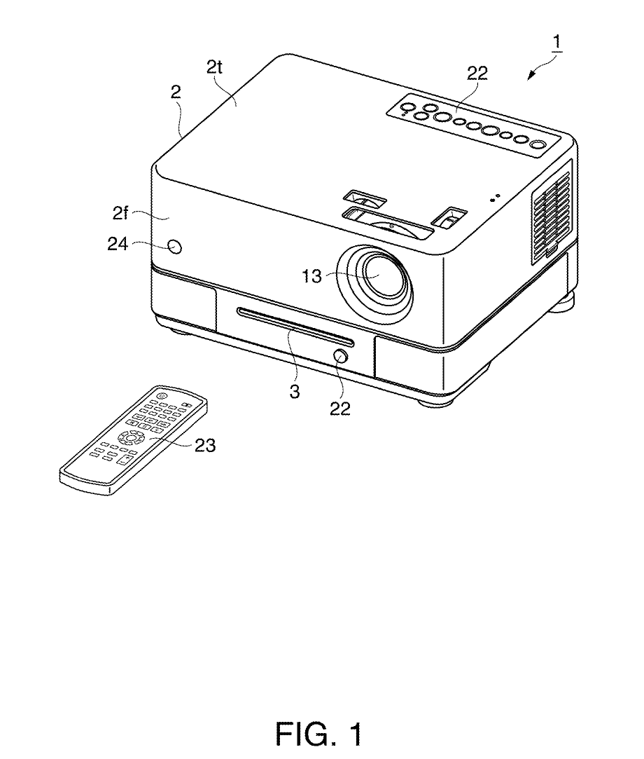

FIG. 1 is a perspective view of the projector according to the present embodiment. As shown in FIG. 1, the projector 1 has a configuration of covering a device main body with a housing 2 forming the exterior. On the front panel 2f of the housing 2 there is exposed a projection lens 13 for projecting an image (image light) on an external screen or the like, and a disk slot 3 for inserting a DVD medium as a recording medium is disposed on the lower side of the projection lens 13. Further, on the front panel 2f of the housing 2 there is disposed an operation signal reception section 24 for receiving an operation signal transmitted from a remote controller 23.

The housing 2 is provided with a main body operation section 22 configured including a plurality of operation keys (operation buttons), so that various instructions to the projector 1 can be provided. Among a plurality of operation keys constituting the main body operation section 22, an operation key (an eject key) for discharging the DVD medium from the disk slot 3 is disposed on the front panel 2f (in the vicinity of the disk slot 3) of the housing 2, and the other operation keys are disposed on a top panel 2t of the housing 2. Further, similarly to the main body operation section 22, the remote controller 23 is also provided with a plurality of operation keys for providing various instructions to the projector 1, so that the remote control of the projector 1 becomes possible.

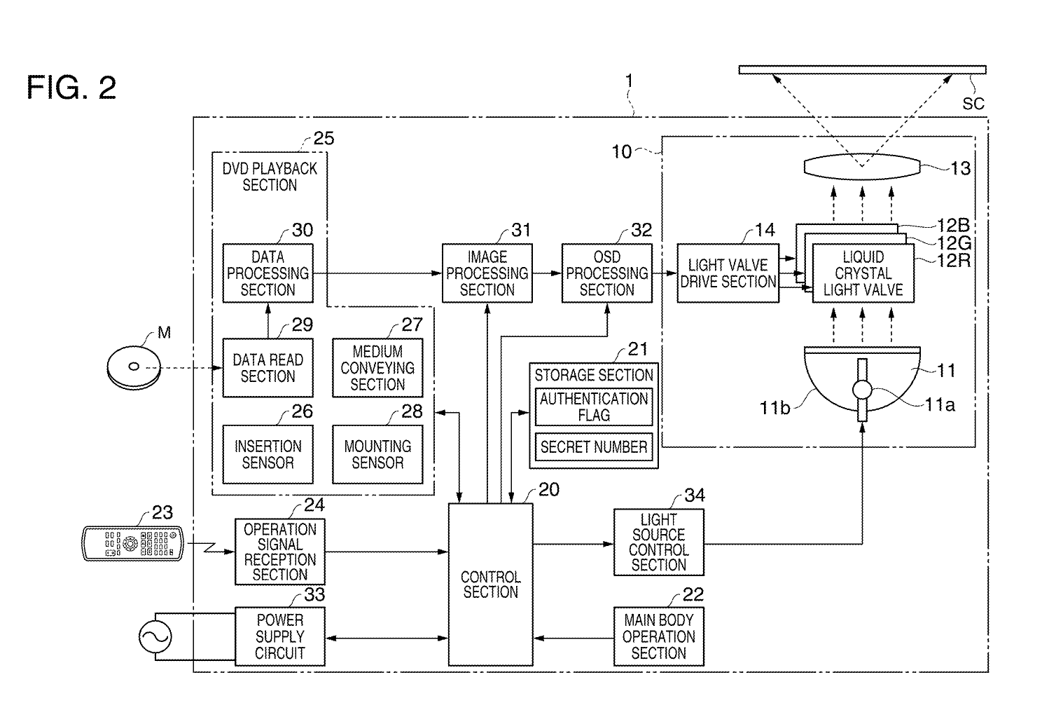

FIG. 2 is a block diagram showing a circuit configuration of the projector. As shown in FIG. 2, the projector 1 is provided with an image projection section 10, a control section 20, a storage section 21, the main body operation section 22, the remote controller 22, the operation signal reception section 24, a DVD playback section 25, an image processing section 31, an OSD processing section 32, a power supply circuit 33, a light source control section 34, and so on.

The image projection section 10 is composed of a light source 11, three liquid crystal light valves 12R, 12G, and 12B as a light modulating device, a projection lens 13 as a projection optical system, a light valve drive section 14, and so on. The image projection section 10 corresponds to a image display section, modulates light emitted from the light source 11 with the liquid crystal light valves 12R, 12G, and 12B to form an image (image light), and then projects the image through the projection lens 13 to thereby display the image on an external screen SC or the like.

The light source 11 is configured including a discharge light source lamp 11a made of, for example, a super-high pressure mercury lamp or a metal halide lamp, and a reflector 11b for reflecting the light, which is emitted by the light source lamp 11a, toward the liquid crystal light valves 12R, 12G, and 12B. The light emitted from the light source 11 is converted into the light having a substantially even intensity distribution by an integrator optical system not shown, and is separated into colored light components of red (R), green (G), and blue (B), the three primary colors of light, by a color separation optical system not shown, and the colored light components subsequently enter the liquid crystal light valves 12R, 12G, and 12B, respectively.

The liquid crystal light valves 12R, 12G, and 12B are each composed mainly of a liquid crystal panel having a liquid crystal material encapsulated between a pair of transparent substrates. The liquid crystal light valves 12R, 12G, and 12B are each provided with a plurality of pixels (not shown) arranged in a matrix, and arranged so that a drive voltage can be applied to the liquid crystal material pixel-by-pixel. When the light valve drive section 14 applies the drive voltages corresponding to image information input thereto to the respective pixels, the respective pixels are each set to have a light transmission rate corresponding to the image information. Therefore, the light emitted from the light source 11 is modulated while being transmitted through the liquid crystal light valves 12R, 12G, and 12B, thus the image light beams corresponding to the image information are formed for the respective colored light. The image light beams of the respective colors are combined pixel-by-pixel by a color combining optical system, not shown, to be formed as a color image light beam, and then projected in an enlarged manner through the projection lens 13.

The control section 20 is provided with a central processing unit (CPU), a random access memory (RAM) used for temporarily storing various data, and so on, and operates along a control program stored in the storage section 21, thereby performing the overall control of the projector 1. In other words, the control section 20 functions as a computer together with the storage section 21.

The storage section 21 is composed mainly of a rewritable nonvolatile memory device such as a flash memory or a ferroelectric RAM (FeRAM). The storage section 21 stores (holds) the control program for controlling the operation of the projector 1, various setting data for providing, for example, operational conditions of the projector 1, and so on. In the present embodiment, there is stored a four-digit secret number looked-up in the valid state of the user authentication function as the setting data together with a flag (an authentication flag) for representing whether the user authentication function is in the valid state or in the invalid state. It should be noted that the authentication flag and the secret number are arranged to be able to be arbitrarily set (changed) by the user.

The main body operation section 22 and the remote controller 23 are each provided with a plurality of operation keys as described above, and each correspond to an input operation section for receiving input operations (operations of the operation keys) of the user. The plurality of operation keys includes a power key for switching the power between ON and OFF, a playback key for starting playback of the DVD medium, a stop key for stopping playback of the DVD medium, and so on besides the eject key described above, and these keys are provided to both of the main body operation section 22 and the remote controller 23. Further, a menu key for displaying a configuration menu or the like in a superimposed manner, direction keys (four operation keys corresponding respectively to the left, right, upper, and lower directions) used in the configuration menu or the like for selecting the items, a determination key for determining the selection of the items, a cancel key for performing cancellation of operations, numerical keys (ten operation keys corresponding respectively to 0 through 9) for inputting the secret number, and so on are provided only to the remote controller 23. When the user operates the various operation keys of the main body operation section 22, the main body operation section 22 outputs an operation signal corresponding to the operation content (the operation key which has been operated) by the user to the control section 20. Further, when the user operates the various operation keys of the remote controller 23, the remote controller 23 generates an infrared operation signal corresponding to the operation content by the user, and then the operation signal reception section 24 receives the signal and transfers it to the control section 20.

The DVD playback section 25 corresponds to an image reproduction section for reproducing the image information recorded on the recording medium (DVD medium M), and is configured including an insertion sensor 26, a medium conveying section 27 as a recording medium conveying section, amounting sensor 28, a data read section 29, a data processing section 30, and so on.

The insertion sensor 26 is disposed in the vicinity of the disk slot 3, and detects the fact that a part of the DVD medium M is inserted in the disk slot 3, and then notifies the control section 20 of the fact.

The medium conveying section 27 is composed of a conveying roller for conveying the DVD medium M, a drive motor (either not shown) for rotationally driving the conveying roller, and so on, and conveys the DVD medium M inside the DVD playback section 25 based on the instruction of the control section 20. Specifically, when the user inserts a part of the DVD medium M into the disk slot 3 from the outside and the insertion sensor 26 detects the insertion, the control section 20 gives an instruction to the medium conveying section 27 to take the DVD medium M inside and mount it on a turntable (not shown). Further, when the user operates the eject key, the control section 20 gives an instruction to the medium conveying section 27 to unload the DVD medium M from the turntable, and then ejects the DVD medium M outside from the disk slot 3.

The mounting sensor 28 is disposed in the vicinity of the turntable, and detects the fact that the DVD medium M is mounted on the turntable and then notifies the control section 20 of the fact.

The data read section 29, based on the instruction of the control section 20, rotates the DVD medium M mounted on the turntable with a spindle motor (not shown), and at the same time, makes an optical pickup (not shown) scan the DVD medium M to thereby sequentially read data stream recorded on the DVD medium M. The data stream corresponds to information of corded image information and corded sound information multiplexed with each other, and the data stream thus read by the data read section 29 is sequentially output to the data processing section 30.

The data processing section 30 is composed of a demultiplexer, a decoder, and so on, and performs a process of separating the data stream input from the data read section 29 into image information and sound information, a process of decoding the image information and the sound information thus separated, and so on based on the instruction of the control section 20. The data processing section 30 outputs the image information thus decoded to the image processing section 31, and outputs the sound information thus decoded to a sound output section not shown. It should be noted that the operation that the DVD playback section 25 reads the data stream from the DVD medium M and outputs the image information based on the data stream will be described in the present specification as “to reproduce the image information” or “to playback the DVD medium M.”

When the main body operation section 22 or the remote controller 23 receives the operation of the playback key, the control section 20 gives an instruction to the DVD playback section 25 to start reproduction of the image information, and when the main body operation section 22 or the remote controller 23 receives the operation of the stop key, the control section 20 gives an instruction to the DVD playback section 25 to stop reproduction of the image information.

The insertion sensor 26 and the mounting sensor 28 can be configured using various types of detector such as a mechanical switch, an optical sensor, or a magnetic sensor. Further, regarding the mounting sensor 28, it is also possible to adopt an aspect of detecting whether or not the DVD medium M is mounted based on a level of a signal corresponding to the reflected light received by the optical pickup described above.

The image processing section 31 converts the image information input from the DVD playback section 25 into the image information representing the grayscales of respective pixels of the liquid crystal light valves 12R, 12G, and 12B, namely the image information for defining the drive voltages applied to the respective pixels. Further, the image processing section 31 executes an image quality controlling process for adjusting brightness, contrast, sharpness, and color on the image information thus converted, following the instruction of the control section 20. The image information on which the image quality controlling process has been performed in the image processing section 31 is output to the OSD processing section 32.

Based on an instruction of the control section 20, the OSD processing section 32 performs processing for displaying an on-screen display (OSD) image such as a menu image or a message image superimposed on the image (the projection image) presently projected. The OSD processing section 32 is provided with an OSD memory not shown, and stores the OSD image information representing figures, a font, and so on for forming the OSD image. When the control section 20 instructs the superimpose display of the OSD image, the OSD processing section 32 reads the necessary OSD image information from the OSD memory, and then combines the OSD image information with the image information input from the image processing section 31 so that the OSD image is superimposed at a predetermined position on the projection image. The image information obtained by combining the OSD image information is then output to the light valve drive section 14. It should be noted that in absence of the instruction from the control section 20 to superimpose the OSD image, the OSD processing section 32 output the image information input from the image processing section 31 directly to the light valve drive section 14.

When the light valve drive section 14 drives the liquid crystal light valves 12R, 12G, and 12B in accordance with the image information thus input, the liquid crystal light valves 12R, 12G, and 12B form the images (image light) corresponding to the image information, and the images are projected on the screen SC through the projection lens 13.

The power supply circuit 33 is supplied with the commercial power of, for example, 100V AC from the outside. The power supply circuit 33 converts the commercial power (alternating-current power) into direct-current power with a predetermined voltage, and supplies each section of the projector 1 with the direct-current power. Further, in accordance with the instruction of the control section 20, the power supply circuit 33 can switch between the state (hereinafter referred to as a “power-ON state”) of supplying each section with the power (the operation power) necessary for the projection of the image and the state (hereinafter referred to as a “standby state” or a “power-OFF state”) of halting the supply of the operation power and waiting for the operation for switching the power on.

The light source section 34 controls supply and stop of the power to the light source 11 based on the instruction from the control section 20, thus switching lighting and extinction of the light source 11.

Since the projector 1 according to the present embodiment is configured as described above, when the commercial power is supplied to the power supply circuit 33, the power supply circuit 33 supplies at least the control section 20, the storage section 21, the main body operation section 22, and the operation signal reception section 24 with the power (the standby power), and the control section 20 starts the operation along the control program in response to the power supply. Immediately after the commercial power has been supplied, the projector 1 is in the standby state (the power-OFF state), and keeps the state in which the light source 11 is OFF.

In the standby state, the user can make the projector 1 make transition to the power-ON state by operating the power key, the playback key, or the eject key provided to the main body operation section 22 and the remote controller 23. Further, it is arranged that it is possible to make projector 1 make transition from the standby state to the power-ON state also by inserting the DVD medium M into the disk slot 3 besides operating the operation keys described above. It should be noted that the operation for setting the projector 1 to the power-ON state, namely an operation of the power key, an operation of the playback key, an operation of the eject key, and an operation of inserting the DVD medium M are each referred to also as an “ON-operation” in the present specification. When the user performs the ON-operation, and the projector 1 makes the transition to the power-ON state, the authentication process is performed, and then the operation different in accordance with the type of the ON-operation is performed if the user authentication is valid.

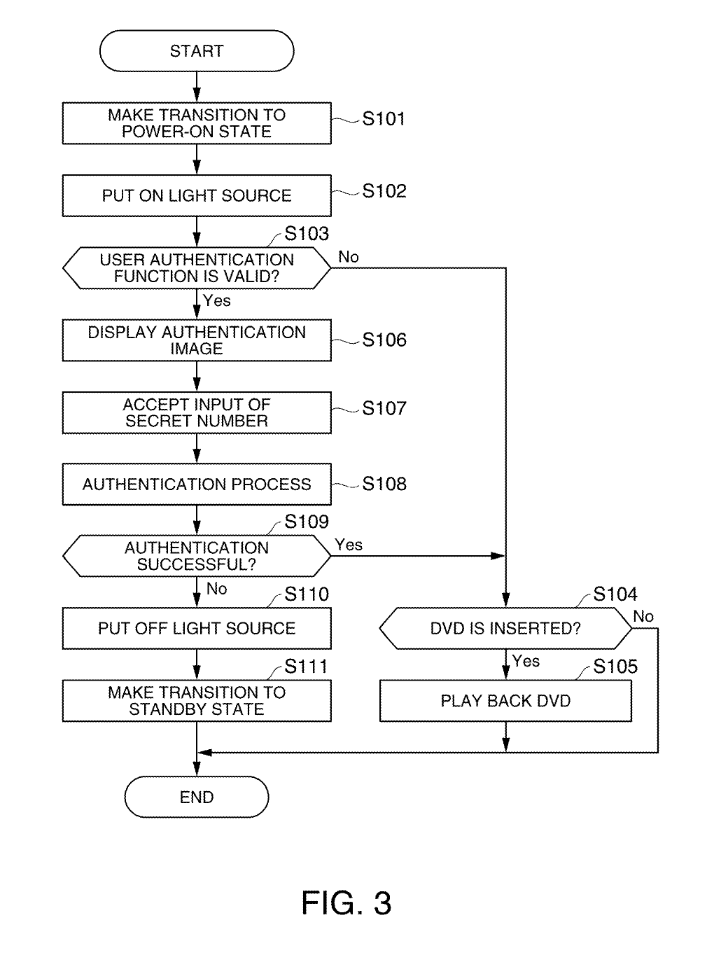

FIG. 3 is a flow chart for explaining an operation of the projector 1 in the case in which the power key or the playback key is operated in the standby state. When the user operates the power key or the playback key in the standby state, the control section 20 operates along the flowchart shown in FIG. 3.

As shown in FIG. 3, in the step S101, the control section 20 instructs the power supply circuit 33 to start to supply each section with the operation power to thereby make the projector 1 make transition to the power-ON state. Further, in the step S102, the control section 20 instructs the light source control section 34 to put on the light source 11 to thereby get into the state capable of projecting the image.

In the step S103, the control section 20 determines whether or not the user authentication function is valid based on the authentication flag stored in the storage section 21. Then, if the user authentication function is invalid, the process proceeds to the step S104, and if the user authentication function is valid, the process proceeds to the step S106.

If the user authentication function is invalid, and the process proceeds to the step S104, the control section 20 determines whether or not the DVD medium M is mounted on the turntable, namely whether or not the DVD medium M is inserted in the disk slot 3, based on the detection result of the mounting sensor 28. Then, if the DVD medium M is not inserted, the process of the flowchart is terminated immediately, and if the DVD medium M is inserted, the process proceeds to the step S105.

If the DVD medium M is inserted in the disk slot 3 and the process proceeds to the step S105, the control section 20 instructs the DVD playback section 25 to start the playback of the DVD medium M, and then terminates the process of the flowchart. As a result, the image (the DVD image) based on the image information reproduced by the DVD playback section 25 is projected from the image projection section 10.

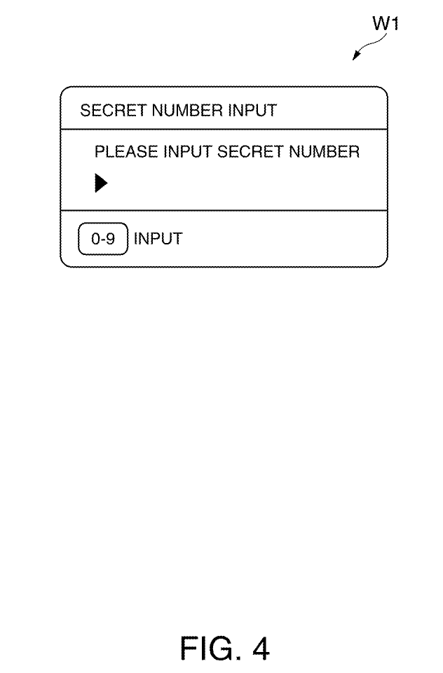

On the other hand, if the user authentication function is valid and the process proceeds to the step S106, the control section 20 instructs the OSD processing section 32 to display the message image (the authentication image W1) for prompting input of the secret number superimposed on the projection image (see FIG. 4). Then, in the step S107, the control section 20 accepts input of the secret number by the user, namely an input operation of the numerical keys provided to the remote controller 23.

In the step S108, the control section 20 performs the authentication process based on the secret number input by the user. Specifically, the control section 20 sequentially recognizes the numerical keys operated, namely the number input thereto, based on the operation signal input from the operation signal reception section 24. Then, when the four numerical characters are input, the control section 20 assumes these numerical characters as a four digit secret number, and compares it with the secret number (a right secret number) stored in the storage section 21. Then, if the secret number input and the right secret number match each other, the user authentication is successful. Further, if the secret numbers do not match each other, the control section 20 makes the OSD processing section 32 display a predetermined message image (not shown) superimposed thereon to notify the user of the fact that the secret number does not match, and to make the user repeat the input of the secret number. Then, in the case in which the secret number fails to match in a predetermined number (e.g., three times) of trials in a row, the user authentication is unsuccessful.

In the step S109, the control section 20 determines whether or not the user authentication is successful based on the result of the authentication process in the step S108. Then, if the user authentication is successful, namely if the right secret number is input before the number of times of mismatch in the secret numbers reaches a predetermined number, the control section 20 makes the OSD processing section 32 terminate the superimposing of the authentication image W1, then the process proceeds to the step S104, and if the DVD medium M is inserted in the disk slot 3, the process of the flowchart is terminated after starting the playback of the medium. Further, thereafter, the projector 1 performs the operation corresponding to the input operation and so on performed by the user. In contrast, if the user authentication is not successful, namely the mismatch in the secret number continues a predetermined number of times, the process proceeds to the step S110.

If the user authentication is unsuccessful and the process proceeds to the step 5110, the control section 20 instructs the light source control section 34 to put off the light source 11. Further, in the step S111, the control section 20 instructs the power supply circuit 33 to stop supplying each section with the operation power to thereby make the projector 1 make transition to the standby state, and terminates the process of the flowchart.

Since the projector 1 operates as described above, the user can make the projector 1 make transition to the power-ON state by operating the power key or the playback key in the standby state. Further, in the case in which the user authentication function is invalid, if the DVD medium M is inserted in the disk slot 3, the playback thereof is automatically started, and the use of the projector 1 becomes thereafter possible. In contrast, in the case in which the user authentication function is valid, the user authentication using the secret number is performed, and the playback of the DVD medium M is started only if the user authentication is successful, and the use of the projector 1 becomes also possible thereafter. In other words, in the case in which the user authentication function is valid, the control section 20 inhibits the playback of the DVD medium M inserted in the disk slot 3 in the standby state until the user authentication becomes successful.

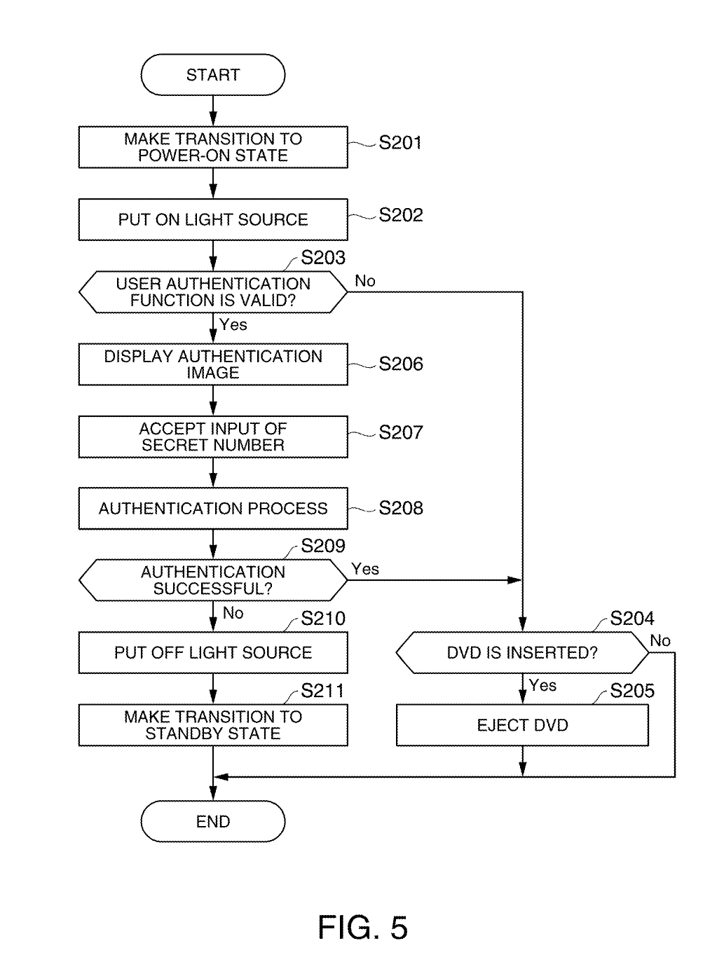

FIG. 5 is a flowchart for explaining the operation of the projector 1 in the case in which the eject key is operated in the standby state. When the user operates the eject key in the standby state, the control section 20 operates along the flowchart shown in FIG. 5. It should be noted that the operation of the steps (steps S201 through S204, and S206 through S209) other than the step S205 is the same as the operation of the steps S101 through S104, and S106 through S109.

Specifically, as shown in FIG. 5, in the step S201, the control section 20 instructs the power supply circuit 33 to start to supply each section with the operation power to thereby make the projector 1 make transition to the power-ON state. Further, in the step S202, the control section 20 instructs the light source control section 34 to put on the light source 11 to thereby get into the state capable of projecting the image.

In the step S203, the control section 20 determines whether or not the user authentication function is valid based on the authentication flag stored in the storage section 21. Then, if the user authentication function is invalid, the process proceeds to the step S204, and if the user authentication function is valid, the process proceeds to the step S206.

If the user authentication function is invalid, and the process proceeds to the step S204, the control section 20 determines whether or not the DVD medium M is mounted on the turntable, namely whether or not the DVD medium M is inserted in the disk slot 3, based on the detection result of the mounting sensor 28. Then, if the DVD medium M is not inserted, the process of the flowchart is terminated immediately, and if the DVD medium M is inserted, the process proceeds to the step S205.

If the DVD medium M is inserted in the disk slot 3 and the process proceeds to the step S205, the control section 20 instructs the DVD playback section 25 to make the medium conveying section 27 eject the DVD medium M having been inserted, and then terminates the process of the flowchart.

On the other hand, if the user authentication function is valid and the process proceeds to the step S206, the control section 20 instructs the OSD processing section to display the authentication image W1 (see FIG. 4) superimposed on the projection image. Then, in the step S207, the control section 20 accepts input of the secret number by the user, namely an input operation of the numerical keys provided to the remote controller 23.

In the step S208, the control section 20 performs the authentication process based on the secret number input by the user, and in the step S209, the control section 20 determines whether or not the user authentication is successful based on the result of the authentication process in the step S208. Then, if the user authentication is successful, namely if the right secret number is input before the number of times of mismatch in the secret numbers reaches a predetermined number of times, the control section 20 makes the OSD processing section 32 terminate the superimposing of the authentication image W1, then the process proceeds to the step S204, and if the DVD medium M is inserted in the disk slot 3, the process of the flowchart is terminated after discharging the medium. Further, thereafter, the projector 1 performs the operation corresponding to the input operation and so on performed by the user. In contrast, if the user authentication is not successful, namely the mismatch in the secret number continues a predetermined number of times, the process proceeds to the step S210.

If the user authentication is unsuccessful and the process proceeds to the step S210, the control section 20 instructs the light source control section 34 to put off the light source 11. Further, in the step S211, the control section 20 instructs the power supply circuit 33 to stop supplying each section with the operation power to thereby make the projector 1 make transition to the standby state, and terminates the process of the flowchart.

Since the projector 1 operates as described above, the user can make the projector 1 make transition to the power-ON state by operating the eject key in the standby state. Further, in the case in which the user authentication function is invalid, if the DVD medium M is inserted in the disk slot 3, the DVD medium M is ejected, and the use of the projector 1 becomes thereafter possible. In contrast, in the case in which the user authentication function is valid, the user authentication process using the secret number is performed, and the DVD medium M is ejected only if the user authentication is successful, and the use of the projector 1 becomes also possible thereafter. In other words, in the case in which the user authentication function is valid, the control section 20 inhibits ejection of the DVD medium M inserted in the disk slot 3 in the standby state until the user authentication becomes successful.

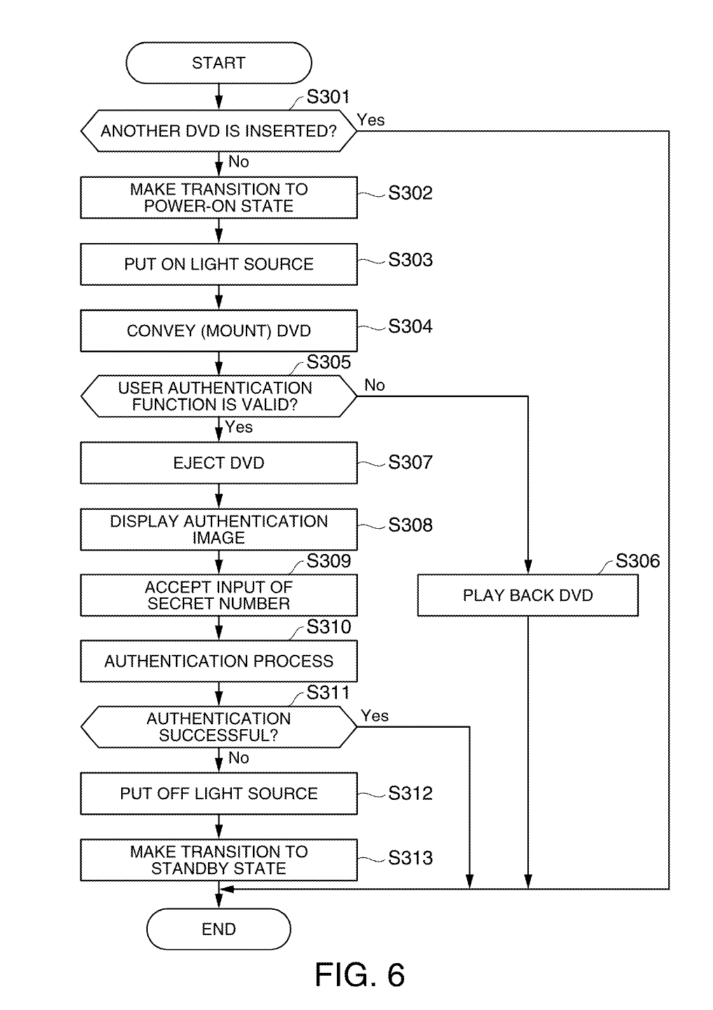

FIG. 6 is a flowchart for explaining the operation of the projector 1 in the case in which the DVD medium M is inserted in the disk slot 3 in the standby state. When the user inserts the DVD medium M in the standby state, and the insertion sensor 26 detects the insertion, the control section 20 operates along the flowchart shown in FIG. 6.

As shown in FIG. 6, in the step S301, the control section 20 determines whether or not the DVD medium M is mounted on the turntable, namely whether or not another DVD medium M is inserted in the disk slot 3, based on the detection result of the mounting sensor 28. Then, if another DVD medium M is inserted, the process of the flowchart is terminated while keeping the standby state, and if the DVD medium M is not inserted, the process proceeds to the step S302.

If another DVD medium M is not inserted in the disk slot 3 and the process proceeds to the step S302, the control section 20 instructs the power supply circuit 33 to start to supply each section with the operation power to thereby make the projector 1 make transition to the power-ON state. Further, in the step S303, the control section 20 instructs the light source control section 34 to put on the light source 11 to thereby get into the state capable of projecting the image.

In the step S304, the control section 20 instructs the DVD playback section 25 to convey the DVD medium M newly inserted therein with the medium conveying section 27 to mount the DVD medium M on the turntable.

In the subsequent step S305, the control section 20 determines whether or not the user authentication function is valid based on the authentication flag stored in the storage section 21. Then, if the user authentication function is invalid, the process proceeds to the step S306, and if the user authentication function is valid, the process proceeds to the step S307.

If the user authentication function is invalid and the process proceeds to the step S306, the control section 20 instructs the DVD playback section 25 to start the playback of the DVD medium M newly inserted therein, and then terminates the process of the flowchart. As a result, the DVD image is projected from the image projection section 10.

On the other hand, if the user authentication function is valid and the process proceeds to the step S307, the control section 20 instructs the DVD playback section 25 to eject the DVD medium M inserted therein using the medium conveying section 27.

In the step S308, the control section 20 instructs the OSD processing section 32 to display the authentication image W1 (see FIG. 4) superimposed on the projection image. Then, in the step S309, the control section 20 accepts input of the secret number by the user, namely an input operation of the numerical keys provided to the remote controller 23.

In the step S310, the control section 20 performs the authentication process based on the secret number input by the user, and in the step S311, the control section 20 determines whether or not the user authentication is successful. Then, if the user authentication is successful, namely the right secret number is input before the number of times of the mismatch in the secret number reaches a predetermined number of times, the control section 20 makes the OSD processing section 32 terminate the superimposing of the authentication image W1, and terminates the process of the flowchart. Further, thereafter, the projector 1 performs the operation corresponding to the input operation and so on performed by the user. For example, when the DVD medium M, which has been ejected in the step S307, is reinserted into the disk slot 3, the control section 20 instructs the DVD playback section 25 to convey the DVD medium M, which is newly inserted, using the medium conveying section 27 to mount it on the turntable. Then, the control section 20 instructs the DVD playback section 25 to start the playback of the DVD medium M inserted therein. In contrast, if the user authentication is not successful in the authentication process in the step S310, namely the mismatch in the secret number continues predetermined number of times, the process proceeds to the step S312.

If the user authentication is unsuccessful and the process proceeds to the step S312, the control section 20 instructs the light source control section 34 to put off the light source 11. Further, in the step S313, the control section 20 instructs the power supply circuit 33 to stop supplying each section with the operation power to thereby make the projector 1 make transition to the standby state, and terminates the process of the flowchart.

Since the projector 1 operates as described above, if the DVD medium M is not mounted on the turntable in the standby state, the user can make the projector 1 make transition to the power-ON state by inserting the DVD medium M into the disk slot 3. Then, in the case in which the user authentication function is invalid, the playback of the inserted DVD medium M is started automatically, and the use of the projector 1 becomes thereafter possible. In contrast, in the case in which the user authentication function is valid, the DVD medium M is ejected instead of starting the playback of the DVD medium M, and the user authentication process using the secret number is performed. Further, it becomes possible to use the projector 1, namely to insert the DVD medium M to perform, for example, the playback thereof only if the user authentication is successful, and if the user authentication is unsuccessful, the projector 1 makes transition to the standby state, and therefore, the playback of the DVD medium M is not performed. In other words, in the case in which the user authentication function is valid, the control section 20 inhibits the playback of the DVD medium M until the user authentication becomes successful. Therefore, the step S313 of making transition to the standby state corresponds to a playback inhibition step.

Here, in the state in which the authentication image W1 is displayed, namely in the state of accepting the input of the secret number, the control section 20 is arranged to ignore the operations of the operation keys related to the operation of the DVD playback section 25 such as the playback key or the eject key, and even if the user operates these operation keys, there is no chance for the DVD medium M to be played back or to be ejected. Further, if the insertion sensor 26 detects the insertion of the DVD medium M in the state in which the authentication image W1 is displayed, although the DVD medium M is conveyed to be mounted on the turntable in the state in which no other DVD media M are inserted, the DVD medium M will thereafter be ejected.

As explained hereinabove, according to the projector 1 of the present embodiment, the following advantages can be obtained.

1. According to the projector 1 of the present embodiment, since there is no chance for the DVD medium M (the image information) to be played back (reproduced) unless the user authentication is successful if the user authentication function is valid, it becomes possible to prevent unauthorized use by unauthorized users.

2. According to the projector 1 of the present embodiment, even if the operation of inserting the DVD medium M is performed, the DVD medium M thus taken in is ejected unless the user authentication is successful if the user authentication function is valid, and therefore, it is possible to make the user recognize that the reproduction of the image information is not achievable. Here, assuming the case of keeping the DVD medium M, which has been inserted therein before the user authentication becomes successful, taken inside the projector 1, and not ejecting it, some users might make a misunderstanding that the playback will be started soon. Further, assuming the case of not performing loading (conveying) itself until the user authentication becomes successful, some users might make a misunderstanding that the projector 1 has a breakdown. In contrast thereto, since in the present embodiment it is arranged that the DVD medium M, which has been inserted before the user authentication becomes successful, is ejected, it is suitable to make the user recognize that the user authentication should be performed.

3. According to the projector 1 of the present embodiment, since the DVD medium M (the image information), which has been inserted in the disk slot 3 in the standby state, is never ejected unless the user authentication becomes successful if the user authentication function is valid, it is prevented that an unauthorized user who does not know the secret number takes out the DVD medium M.

It should be noted that in the present embodiment, the control section 20 when executing the authentication process in the steps S108 (see FIG. 3), S208 (see FIGS. 5), and S310 (see FIG. 6) corresponds to an authentication section. Further, the operation of inserting the DVD medium M into the disk slot 3 for making the medium conveying section 27 load the DVD medium M corresponds to a loading operation, and the insertion sensor 26 for detecting the insertion of the DVD medium M corresponds to a loading operation detection section. Further, the operation of the eject key for making the medium conveying section 27 eject the DVD medium M corresponds to an ejection operation, and the main body operation section 22 and the remote controller 23 correspond to an ejection operation detection section.

### Modified Examples

Further, the embodiment described above can be modified as follows.

Although in the embodiment described above it is arranged that the DVD medium M newly inserted into the disk slot 3 is ejected until the user authentication becomes successful, the ejection is not necessarily required, but it is also possible to leave it mounted on the turntable. In other words, it is also possible to adopt a configuration of eliminating the step S307 in the flowchart shown in FIG. 6.

Further, although in this case, it is also possible to arrange that the user can freely perform insertion of a new DVD medium M or ejection of the DVD medium M using the eject key providing that the DVD medium M inserted in the standby state is prevented from being ejected before the user authentication becomes successful. In order for realizing this arrangement, it is sufficient to detect whether or not the DVD medium M is mounted on the turntable using the mounting sensor 28 in the transition from the standby state to the power-ON state, and to permit the insertion of the DVD medium M and the ejection thereof by the eject key only if the DVD medium M is not mounted.

Although in the embodiment described above the DVD medium M newly inserted into the disk slot 3 is ejected after once mounted on the turntable until the user authentication becomes successful, it is not necessarily required to mount the DVD medium M on the turntable. Specifically, it is also possible to arrange that the DVD medium M is loaded halfway, and then ejected without mounting it on the turntable. Further, it is also possible to eliminate the steps S304, S307 in the flowchart shown in FIG. 6 to thereby realize the case of inhibiting the new loading of the DVD medium M itself. In this case, if it is attempted to insert the DVD medium M prior to the successful user authentication, the DVD medium M is not loaded at all, and therefore, it is possible to make the user recognize that the reproduction of the image information is not achievable.

Although in the embodiment described above there is shown the configuration of including the DVD playback section 25 capable of reading the information recorded on the DVD medium M, it is also possible to adopt a configuration capable of reading information recorded on other recording media such as an optical disk (e.g., a Blu-ray disc) other than the DVD, various types of semiconductor memory, a magnetic disk, or a magnetic tape. Also in such cases, it is preferable to adopt a configuration in which the recording medium can be ejected only if the user authentication is successful, or a configuration in which the recording medium can be detached only if the user authentication is successful so that the recording medium is not taken out by unauthorized users.

Although in the embodiment described above, there is shown a configuration of performing the user authentication using the secret number, it is also possible to arrange that the authentication is performed using a password including alphabetical characters or symbols. Alternatively, it can be taken as a requirement of the authentication to operate various function keys provided to the main body operation section 22 and the remote controller 23 in a predetermined order (sequence). Further, it is also possible to use various authentication methods such as biometric authentication including fingerprint authentication.

Although in the embodiment described above, a slot-in mechanism for directly inserting the DVD medium M into the disk slot 3 is adopted as a mechanism of loading the DVD medium M to the DVD playback section 25, the mechanism is not limited to the slot-in mechanism, but for the DVD playback section 25, for example, a tray loading mechanism for conveying the DVD medium M while being mounted on a tray can be adopted. In the case of the tray loading mechanism, since it is required to operate the eject key to draw the tray to the outside in the case of loading the DVD medium M and in the case of ejecting the DVD medium M, the operation of the eject key corresponds to both of the loading operation and the ejection operation. Therefore, when inhibiting the loading or the ejection of the DVD medium M, it is sufficient to inhibit the drawing operation of the tray corresponding to the operation of the eject key.

Further, it is also possible to adopt a top loading mechanism in which the user opens an open/close lid covering the turntable, and mounts the DVD medium M directly on the turntable. In the case of the top loading mechanism, since it is required to operate the eject key to release the open/close lid in the case of loading the DVD medium M and in the case of ejecting the DVD medium M, the operation of the eject key corresponds to both of the loading operation and the ejection operation. Therefore, when inhibiting the loading or the ejection of the DVD medium M, it is sufficient to inhibit the releasing operation of the open/close lid.

Although in the embodiments described above the transmissive liquid crystal light valves 12R, 12G, and 12B are used as the light modulation device, it is also possible to use a reflective light modulation device such as a reflective liquid crystal light valves. Further, a micromirror array device for modulating the light emitted from the light source by controlling the emission direction of the incident light of every micromirror as a pixel can also be used.

Although in the embodiment described above, the light source 11 is configured with the discharge light source lamp 11a, a sold-state light source such as a light emitting diode (LED) light source or other light sources can also be used therefor.

Although in the embodiment described above, the explanation is presented taking the projector 1 for modulating the light emitted from the light source 11 and then projecting the modulated light as an example of the image display device, it is also possible to apply the invention to other image display devices such as a rear projector integrally provided with a transmissive screen, a liquid crystal display, a plasma display, a surface-conduction electron-emitter display (SED), or an organic electro luminescence (EL) display.

What is claimed is:

1. An image display device comprising:
an image reproduction section adapted to reproduce image information recorded on a recording medium mounted;
an image display section adapted to display an image corresponding to the image information reproduced by the image reproduction section;
a control section adapted to make the image reproduction section start reproduction of the image information if the recording medium is mounted to the image reproduction section; and
an authentication section adapted to perform user authentication,
wherein the control section inhibits the image reproduction section from reproducing image information until the user authentication by the authentication section becomes successful.

2. The image display device according to claim 1, further comprising:
a recording medium conveying section adapted to load the recording medium from outside and to mount the recording medium to the image reproduction section; and
a loading operation detection section adapted to detect a loading operation for making the recording medium conveying section load the recording medium,
wherein the recording medium conveying section loads the recording medium and then ejects the recording medium outside if the loading operation detection section detects the loading operation before the user authentication by the authentication section becomes successful.

3. The image display device according to claim 1, further comprising:
a recording medium conveying section adapted to load the recording medium from outside and to mount the recording medium to the image reproduction section; and
a loading operation detection section adapted to detect a loading operation for making the recording medium conveying section load the recording medium,
wherein the recording medium conveying section inhibits loading of the recording medium if the loading operation detection section detects the loading operation before the user authentication by the authentication section becomes successful.

4. The image display device according to claim 1, further comprising:
a recording medium conveying section adapted to load the recording medium from outside and to mount the recording medium to the image reproduction section,
wherein the recording medium conveying section inhibits ejection of the recording medium, which is loaded prior to power ON, until the user authentication by the authentication section becomes successful.

5. The image display device according to claim 1, wherein
a mechanism adapted to mount the recording medium to the image reproduction section is a slot-in mechanism.

6. The image display device according to claim 1, wherein
a mechanism adapted to mount the recording medium to the image reproduction section is a tray loading mechanism.

7. The image display device according to claim 1, wherein
a mechanism adapted to mount the recording medium to the image reproduction section is a top-loading mechanism.

8. The image display device according to claim 1, wherein
the authentication section determines whether a user authentication function is active or inactive, and performs the user authentication if the user authentication function is active, and
the control section inhibits the image reproduction section from reproducing image information until the user authentication by the authentication section becomes successful.

9. A projector comprising:
an image reproduction section adapted to reproduce image information recorded on a recording medium mounted;
an image display section adapted to display an image corresponding to the image information reproduced by the image reproduction section;
a control section adapted to make the image reproduction section start reproduction of the image information if the recording medium is mounted to the image reproduction section; and
an authentication section adapted to perform user authentication,
wherein the control section inhibits the image reproduction section from reproducing image information until the user authentication by the authentication section becomes successful, and
the image display section performs an image projection to project the image corresponding to the image information reproduced by the image reproduction section.

10. The projector according to claim 9, further comprising
a light source adapted to supply illumination light for the image projection,
wherein the projector is powered ON, the light source is made to make transition to a lighting state, and the user authentication is performed by performing one of the loading operation and the reproduction operation in a standby state with the light source put OFF, and
if the user authentication is unsuccessful, the projector is powered OFF and made to make transition to a playback inhibition state as a standby state for putting OFF the light source.

11. A method of controlling an image display device having an image reproduction section adapted to reproduce image information recorded on a recording medium mounted, comprising:
(a) detecting a loading operation adapted to load the recording medium from outside and mount the recording medium to the image reproduction section;
(b) performing user authentication if the loading operation is detected; and
(c) inhibiting reproduction of the image information by the image reproduction section if the user authentication is unsuccessful in step (b).

12. The method of controlling an image display device according to claim 11, wherein
the recording medium is loaded and then ejected outside if the loading operation is detected in step (a) before the user authentication in step (b) becomes successful.

13. The method of controlling an image display device according to claim 11, wherein
loading of the recording medium from outside is inhibited if the loading operation is detected in step (a) before the user authentication in step (b) becomes successful.
